(19) United States
(12) Patent Application Publication
(10) Pub. No.: US 2014/0079311 A1
(43) Pub. Date: Mar. 20, 2014

(54) SYSTEM, METHOD AND COMPUTER PROGRAM PRODUCT FOR CLASSIFICATION

(71) Applicants: Moshe Amzaleg, Beer Sheva (IL); Nir Ben-David, Hod Hasharon (IL)

(72) Inventors: Moshe Amzaleg, Beer Sheva (IL); Nir Ben-David, Hod Hasharon (IL)

(73) Assignee: Applied Materials Israel Ltd., Rehovot (IL)

(21) Appl. No.: 13/623,815

(22) Filed: Sep. 20, 2012

(51) Int. Cl. G06K 9/62

(52) U.S. Cl. 382/144; 382/224; 382/165

(57) ABSTRACT

A computerized system for classification of pixels in an inspection image into noise-indicative populations, the system including: an interface operable to obtain an inspection image and to provide information of the inspection image to a processor connected thereto which includes: a noise estimation module and a classification module configured to and provide a classification of the plurality of pixels of the inspection image into noise-indicative population types.

### FIELD OF THE INVENTION

This invention relates to systems and methods for classification of pixels in an inspection image.

### BACKGROUND OF THE INVENTION

When an object is inspected to provide an image thereof, different parts of the object are imaged with different levels of noise. For example, when electronic circuits (e.g. a wafer or a part thereof) are imaged—a conducting part of the electronic circuit may be imaged having a different noise level than an insulating part of the same electronic circuit. This may happen in different kinds of imaging techniques (e.g. electron beam scanning, optical scanning), and for different kinds of imaged objects and materials.

For example, FIG. 1 illustrates a representation 20 of part of a die of a wafer, which includes conducting parts (illustrated by the black squares), and isolating parts (illustrated by the white squares).

Different parameters may be used to assess noise in an image, and to classify pixels into different noise-indicative population types. For example, the difference between the gray level (GL) of the brightest pixel in an area surrounding a pixel (e.g. a 5×5 pixels kernel area, centered around the pixel) to the gray level of the darkest pixel in that area, may be used. Other parameters which may be used are statistical variance (i.e. the average of the squared differences of the GL of the different pixels of the kernel from the mean GL in that kernel, also referred to by the abbreviation VAR). Clearly, other parameters indicating noise may be used.

Image 30 illustrated in FIG. 1 is a result of noise-estimation analysis, and may be generated by comparison of the noise-indicative value (e.g. the variance) of each pixel of an inspection image (not illustrated) of the die represented by 20 to a threshold. The black pixels in image 30 are pixels whose noise-indicative value (e.g. the variance value) is higher than the threshold, and are therefore considered noisy, while the white pixels in image 30 are pixels whose noise-indicative value is lower than the threshold, and are therefore considered quiet.

Clearly, pixels of the image that are imaged in a lower noise level may provide more exact results, and hence more minute defects may be detected in those areas (e.g. in a defect detection inspection of a wafer). The determination of noise level, however, is based on an analysis of the inspection image—whose very own generation depends directly on the noise level.

Noise, the variation of color information in the inspection image (which may be produced by the sensor and/or connected circuitry), is of a statistical nature (and is possibly downright random). Therefore, noise included in the inspection image may result in erroneous identification of a part of the inspection image that corresponds to a substantially noisy part of the inspected object (i.e. a part of it whose imaging results in noisier results) as a quiet part of the inspection image, and vice versa.

A current classification mechanism which is responsible to segment the noise population based on the noise-indicative value determined of each pixel is intolerable for small impurities (i.e. a few pixels 32 segmented as a quiet type, surrounded by pixels of a noisier type), because those pixels—which should actually be classified as noisy—raise the noise levels in the quiet population of pixels (exactly where sensitivity should be at its highest level).

Classification of noisy pixels as quiet ones would result in a high result of false defects detected, while classification of quiet pixels as noisy ones would lower the accuracy of the detection (as it requires the raising of the threshold required for defect detection) and results in missing of actual defects. There is therefore a need to provide systems and methods for better differentiation between different noise-indicative population types in inspection images.

### SUMMARY OF THE INVENTION

In accordance with an aspect of the presently disclosed subject matter, there is provided a computerized system for classification of pixels in an inspection image into noise-indicative populations, the system including an interface operable to obtain an inspection image and to provide information of the inspection image to a processor connected thereto, the processor, including a noise estimation module, configured to analyze at least a part of the inspection image to determine a noise-indicative value for each pixel out of a plurality of pixels of the part of the inspection image; and a classification module configured to (a) assign an initial noise-indicative population type to each pixel of the plurality of pixels based on the noise-indicative value of that pixel, thus yielding a plurality of classified pixels; (b) process at least some of the plurality of classified pixels, thereby assigning to at least one of the plurality of reclassified pixels a posterior noise-indicative population type which is different from the initial noise-indicative population type assigned to that reclassified pixel, based on the noise-indicative values determined for multiple other pixels which are proximate to that reclassified pixel; and (c) provide a classification of the plurality of pixels of the inspection image into noise-indicative population types, wherein the classification of at least one reclassified pixel is based on the posterior noise-indicative population type assigned to that reclassified pixel.

In accordance with an embodiment of the presently disclosed subject matter, the inspected image may be a result of an inspection of an inspected object which is selected from a group consisting of an electronic circuit, a wafer, and a photomask.

In accordance with an embodiment of the presently disclosed subject matter, the classification module may be configured to assign the initial noise-indicative population types to each of the plurality of pixels irrespective of the noise-indicative values determined for any other pixel of the inspection image.

In accordance with an embodiment of the presently disclosed subject matter, the classification module may be further configured to determine classification rules, prior to assigning the initial noise-indicative population types, wherein the classification module may be configured to (a) determine the classification rules in response to the noise-indicative values of multiple pixels out of the plurality of pixels; and (b) assign the initial noise-indicative population types further based on the classification rules.

In accordance with an embodiment of the presently disclosed subject matter, the noise estimation module may be configured to determine for each analyzed pixel out of the plurality of pixels a value of a distribution-indicative parameter that is responsive to color-levels of pixels in a predetermined-sized environment of that analyzed pixel.

In accordance with an embodiment of the presently disclosed subject matter, there is yet further provided a system, wherein the noise estimation module is configured to analyze the part of the inspection image to determine for each of the plurality of pixels multiple noise-indicative values of multiple noise indicative parameters; wherein the classification module is configured to: (a) assign to each pixel of the plurality of pixels the initial noise-indicative population type based on the multiple noise-indicative values of that pixel; and (b) assign the posterior noise-indicative population type to the at least one reclassified pixel based on the multiple noise-indicative values determined for each of the multiple proximate pixels.

In accordance with an embodiment of the presently disclosed subject matter, the classification module may be configured to process at least some of the plurality of classified pixels by analyzing each pixel of at least one type of the initial noise-indicative population types, based on the noise-indicative values determined for multiple other pixels which are proximate to the respective pixel.

In accordance with an embodiment of the presently disclosed subject matter, the system may further include a defects detection module configured to detect defects in an inspected object that is imaged in the inspection image; wherein the defect detection module is configured to detect defects in each compared pixel of the inspection image based on a comparison of a color level of the compared pixel to the color level of a corresponding reference pixel and on the provided classification of that pixel into a noise-indicative population type.

In accordance with an aspect of the presently disclosed subject matter, there is yet further provided a computerized method for classification of pixels in an inspection image into noise-indicative populations, the method including analyzing with the help of a processor at least a part of the inspection image to determine a noise-indicative value for each pixel out of a plurality of pixels in the part of the inspection image; assigning with the help of the processor an initial noise-indicative population type to each pixel of the plurality of pixels based on the noise-indicative value of that pixel, thus yielding a plurality of classified pixels; processing, with the help of the processor, at least some of the plurality of classified pixels, thereby assigning to at least one of the plurality of classified pixels a posterior noise-indicative population type which is different from the initial noise-indicative population type assigned to that reclassified pixel, based on the noise-indicative values determined for multiple other pixels which are proximate to that reclassified pixel; and providing with the help of the processor a classification of the plurality of pixels of the inspection image into noise-indicative population types, wherein the classification of at least one reclassified pixel is based on the posterior noise-indicative population type assigned to that reclassified pixel.

In accordance with an embodiment of the presently disclosed subject matter, the inspected image is a result of an inspection of an inspected object which is selected from a group consisting of an electronic circuit, a wafer, and a photomask.

In accordance with an embodiment of the presently disclosed subject matter, the processing may include processing with the help of the processor at least some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels.

In accordance with an embodiment of the presently disclosed subject matter, the assigning of the initial noise-indicative population type to each of the plurality of pixels may be irrespective of the noise-indicative values determined for any other pixel of the inspection image.

In accordance with an embodiment of the presently disclosed subject matter, the assigning of the initial noise-indicative population types may be preceded by determining classification rules in response to the noise-indicative values of multiple pixels out of the plurality of pixels; and wherein the assigning of the initial noise-indicative population type may further be based on the classification rules.

In accordance with an embodiment of the presently disclosed subject matter, the analyzing may include determining for each analyzed pixel out of the plurality of pixels a value of a distribution-indicative parameter that is responsive to color-levels of pixels in a predetermined-sized environment of that analyzed pixel.

In accordance with an embodiment of the presently disclosed subject matter, the analyzing may include analyzing the part of the inspection image to determine for each of the plurality of pixels multiple noise-indicative values of multiple noise indicative parameters; wherein the assigning of the initial noise-indicative population type to each pixel of the plurality of pixels may be based on the multiple noise-indicative values of that pixel; and wherein the processing may include assigning the posterior noise-indicative population type to the at least one reclassified pixel based on the multiple noise-indicative values determined for each of the multiple proximate pixels.

In accordance with an embodiment of the presently disclosed subject matter, the processing may be a result of an analysis of each pixel of at least one type of the initial noise-indicative population types, based on the noise-indicative values determined for multiple other pixels which are proximate to the respective pixel.

In accordance with an embodiment of the presently disclosed subject matter, the method may further include detecting defects in an inspected object that is imaged in the inspection image; wherein the detecting of the defects in each compared pixel of the inspection image is based on a comparison of a color level of the compared pixel to the color level of a corresponding reference pixel and on the provided classification of that pixel into a noise-indicative population type.

In accordance with an aspect of the presently disclosed subject matter, there is yet further provided a program storage device readable by machine, tangibly embodying a program of instructions executable by the machine to perform method for classification of pixels in an inspection image into noise-indicative populations including the steps of: (a) analyzing at least a part of the inspection image to determine a noise-indicative value for each pixel out of a plurality of pixels of the part of the inspection image; (b) assigning an initial noise-indicative population type to each pixel of the plurality of pixels based on the noise-indicative value of that pixel, thus yielding a plurality of classified pixels; (c) processing at least some of the plurality of classified pixels, thereby assigning to at least one of the plurality of classified pixels a posterior noise-indicative population type which is different from the initial noise-indicative population type assigned to that reclassified pixel, based on the noise-indicative values determined for multiple other pixels which are proximate to that reclassified pixel; and (d) providing a classification of the plurality of pixels of the inspection image into noise-indicative population types, wherein the classification of at least one reclassified pixel is based on the posterior noise-indicative population type assigned to that reclassified pixel.

In accordance with an embodiment of the presently disclosed subject matter, the instructions included in the program of instructions for the step of processing may include instructions for processing the at least some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels.

In accordance with an embodiment of the presently disclosed subject matter, the instructions included in the program of instructions for the step of assigning may include instructions for assigning the initial noise-indicative population type to each of the plurality of pixels irrespective of the noise-indicative values determined for any other pixel of the inspection image.

In accordance with an embodiment of the presently disclosed subject matter, the program of instructions may include instructions for determining classification rules in response to the noise-indicative values of multiple pixels out of the plurality of pixels; wherein the assigning of the initial noise-indicative population type is further based on the classification rules.

In accordance with an embodiment of the presently disclosed subject matter, the instructions included in the program of instructions for the step of analyzing may include instructions for determining for each analyzed pixel out of the plurality of pixels a value of a distribution-indicative parameter that is responsive to color-levels of pixels in a predetermined-sized environment of that analyzed pixel.

In accordance with an embodiment of the presently disclosed subject matter, the instructions included in the program of instructions for the step of analyzing may include instructions for analyzing the part of the inspection image to determine for each of the plurality of pixels multiple noise-indicative values of multiple noise indicative parameters; wherein the assigning of the initial noise-indicative population type to each pixel of the plurality of pixels is based on the multiple noise-indicative values of that pixel; and wherein the processing includes assigning the posterior noise-indicative population type to the at least one reclassified pixel based on the multiple noise-indicative values determined for each of the multiple proximate pixels.

In accordance with an embodiment of the presently disclosed subject matter, the processing may be a result of an analysis of each pixel of at least one type of the initial noise-indicative population types, based on the noise-indicative values determined for multiple other pixels which are proximate to the respective pixel.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 illustrates a representation of part of a die of a wafer, and a result of noise-estimation analysis applied thereon;

FIG. 2A is a schematic illustration of a distribution of pixels in an inspection image, based on the value of a noise-indicative value calculated for each of those pixels, according to an embodiment of the invention;

FIG. 2B is a distribution of pixels from an actual inspection image, according to an embodiment of the invention;

FIG. 3 is a block diagram of a computerized system for classification of pixels in an inspection image into noise-indicative populations, according to an embodiment of the invention;

FIG. 4 illustrates a computerized method for classification of pixels in an inspection image into noise-indicative populations, according to an embodiment of the invention;

FIG. 5 illustrates a computerized method for classification of pixels in an inspection image into noise-indicative populations, according to an embodiment of the invention;

FIG. 6 illustrates a processing of an inspection image, according to an embodiment of the invention;

FIG. 7 includes a graph which includes histograms of the differences in the gray level (GL) values between the inspection image and a reference image, according to an embodiment of the invention; and

FIG. 8 illustrates a comparison between defect detection enabled by the proposed systems and methods and between other techniques of defect detection.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “determining”, “generating”, “selecting”, or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture. In accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

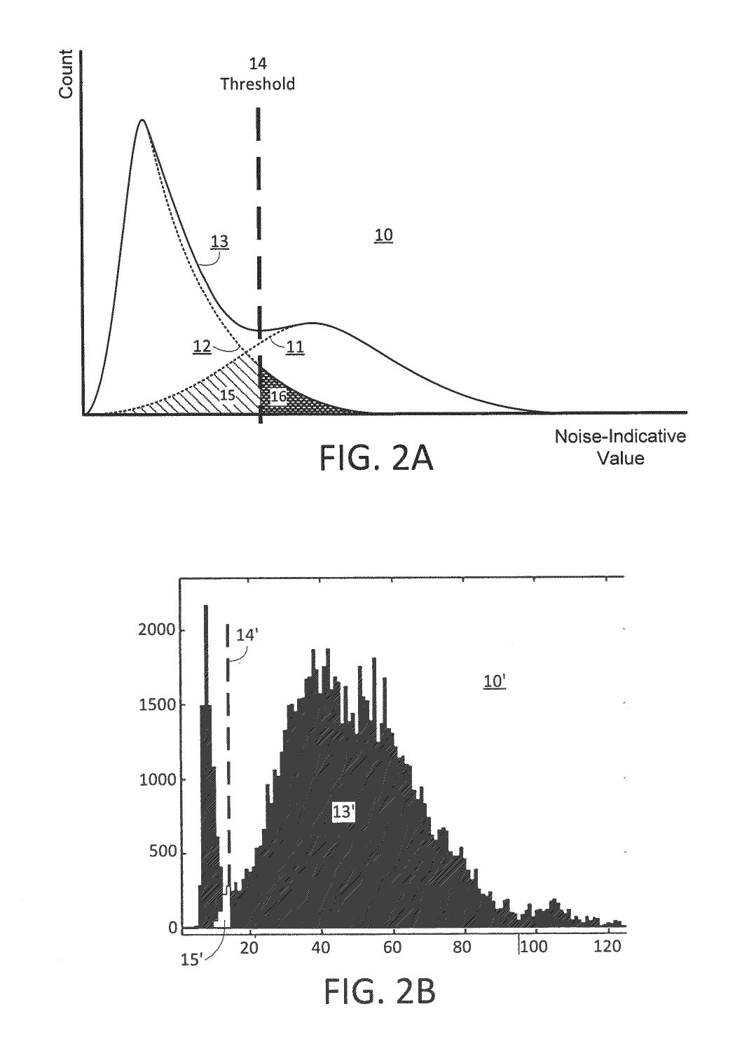

FIG. 2A is a schematic illustration of a distribution 13 of pixels in an inspection image, based on the value of a noise-indicative value calculated for each of those pixels, according to an embodiment of the invention. The abscissa of graph 10 on which curve 13 is plotted represents the value of the noise-indicative parameter, while the ordinate represents number of pixels having that value. The noise-indicative value of a pixel may be based on the gray levels of all of the pixels in an area surrounding that pixel (e.g. a 5×5 pixels kernel area, with the aforementioned pixel at the center). In but a few examples, the noise-indicative value may be the range of gray levels (the difference between the gray level of the brightest pixel in the kernel to the gray level of the darkest pixel in that area), the statistical variance of those gray levels, and so on.

FIG. 2B is a distribution 13′ of pixels from an actual inspection image, based on the range of GL of the pixels in a 5×5 area centered around the respective pixel, according to an embodiment of the invention. The numbers used for denotation with respect to FIG. 2B are the same as those used in FIG. 2A, with an apostrophe added (i.e. distribution 13′ corresponds to distribution 13, but with real-life values, etc.).

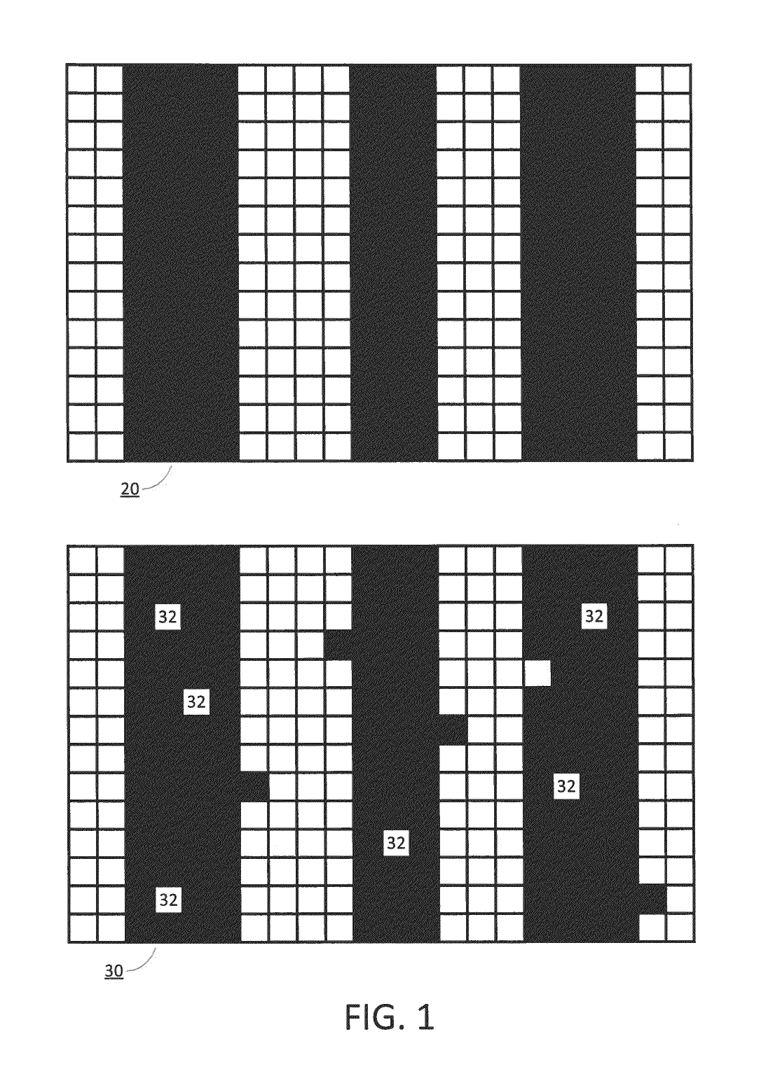

The inspected object which is imaged at the inspection image that is schematically represented by graph 10 is assumed to include two types of imaged substance (e.g. conducting and insulating material), which are imaged with different characteristic noise levels (e.g. as in the example of image 20 of FIG. 1). Each of these two types of imaged substances correspond to one of the two pixel populations 11 and 12.

Pixels whose noise-indicative value is high are regarded as noisy, and pixels whose noise-indicative value is low are regarded as quiet. The overall population represented by curve 13 is the sum of the two populations 11 and 12, each having a substantially normal (or lognormal) distribution. Distribution 11 represents a population of noisy pixels (i.e. pixel in which a noisy part of the inspected object is imaged) while distribution 12 represents a population of quiet pixels. It should be noted that while the different populations are assumed to be normally (or log-normally) distributed, in actual implementations other distributions may applied.

The distributions 11 and 12 are assumed to be the “actual” populations, i.e. all of the pixels that belong to one of the populations 11 or 12 are pixels in which parts of the inspected object that are characterized by the same inclination to noise are imaged. However, the actual population to which each of the pixels of the inspection image belong is not available, and may only be assessed based on the information included in the inspection image.

Since there is an overlap between the noise-indicative values of pixels of the two populations (the combination of areas 15 and 16), attempting to differentiate the pixels into different populations by comparing the noise-indicative value of each of the pixels to a threshold value 14 would inevitably result in erroneous classifications of some of the pixels. Some pixels that belong to the noisy population (represented by 11) would be classified as pixels of a quiet type (those pixels are represented by area 15), and some pixels that belong to the quiet population (represented by 12) would be classified as pixels of a noisier type (those pixels are represented by area 16). Such incorrect classification as a result of a mere comparison with a threshold is inevitable if there is any overlap between any two or more populations.

The systems and methods discussed below utilize spatial attributes for the classification of pixels into multiple noise-indicative population types. Implementation of these systems and/or methods would result in improved classification, increased sensitivity on quiet population types, and/or increased classification stability.

It is noted that the number of noise-indicative population types (also referred to as “noise-related classes”) to which the different pixels of the image may be classified may differ based on the implementation. For example, four, ten, and fifty noise-indicative population types may be implemented. For the sake of the following disclosure it is assumed that pixels are classified in a binary fashion, either as a quiet pixel (i.e. belonging to a noise-indicative population type which indicates a quieter population, or belonging to a noise-indicative population type which indicates a noisier population). Since the classification into population types is based on an inspection image that is obtained in a process that is susceptible to noise, it should be noted that while one noise-indicative population type may indicate a quieter population than the population of pixels classified as another noise-indicative population type, it does not mean that every single pixel of the first population type indeed has lower noise level than any pixel of the second population type.

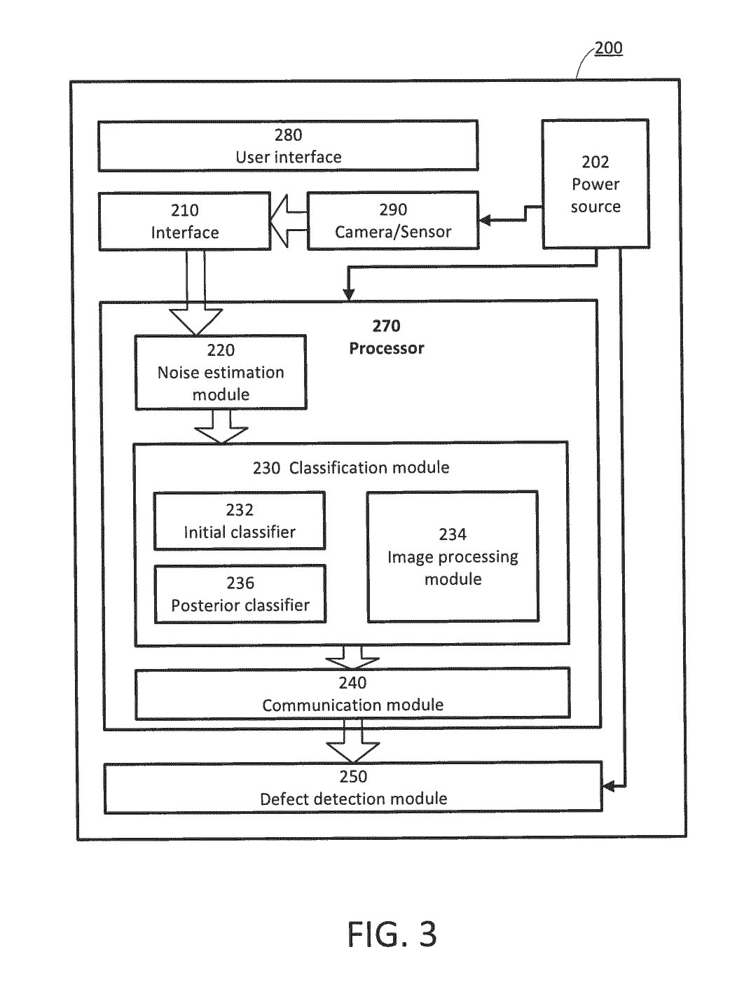

FIG. 3 is a block diagram of computerized system 200 for classification of pixels in an inspection image into noise-indicative populations, according to an embodiment of the invention. While not necessarily so, the inspection image may be an image of an inspected object which is selected from a group consisting of an electronic circuit, a wafer, and a photomask. System 200 may be combined with an inspection machine that is used to inspect the wafer or other types of inspected object (e.g. during different stages of manufacturing thereof). In another implementation system 200 may be connected to such an inspection machine, but this is not necessarily so. Also, system 200 may be an inspection machine into which some or all of the modifications and/or features discussed below have been integrated. Some of the ways in which system 200 may operate will become clearer when viewed in the light of methods 500 and 600 discussed below.

System 200 includes noise estimation module 220 that is configured to analyze at least a part of the inspection image, to determine a noise-indicative value for each pixel out of a plurality of pixels of the part (or parts) of the inspection image. For example, the noise estimation module may be configured to determine for each pixel out of the plurality of pixels the range of gray level values of the pixels in an area sized 5 pixels by 5 pixels surrounding the pixel. The plurality of pixels may include all of the pixels of the inspection image, all of the pixels in one or more areas (e.g. in a rectangular area), and/or other distribution of pixels. Examples of ways in which noise estimation module 220 may operate are discussed in further detail in relation to stages 510 and 610 of respective methods 500 and 600. The inspection image itself may be obtained directly from a camera 290 (or other type of sensor), or from an external system (not illustrated). System 200 may also include an interface 210 which is operable to obtain the inspection image (e.g. from one of the above mentioned sources) and to provide information of the inspection image to a processor such as processor 270 which is connected thereto (i.e. to interface 210).

Processor 270 (which may be an analogue processor, a digital processor, and a combination thereto) may include several modules, such as noise estimation module 220, classification module 230, and communication module 240. Processor 270 includes hardware components, and may also include firmware and/or software components.

According to an embodiment of the invention, noise estimation module 210 is configured to determine for each analyzed pixel out of the plurality of pixels, a value of a distribution-indicative parameter that is responsive to color-levels of pixels in a predetermined-sized environment of that analyzed pixel.

It is noted that instead of analyzing the inspection image by noise estimation module 220, system 200 may alternatively receive the noise indicative values of the different pixels from an auxiliary source.

System 200 further includes classification module 230, which is configured to: (a) assign an initial noise-indicative population type to each pixel of the plurality of pixels, based on the noise-indicative value of that pixel, thus yielding in a plurality of classified pixels; and (b) process at least some of the plurality of classified pixels, thereby assigning to at least one of the plurality of reclassified pixels a posterior noise-indicative population type which is different than the initial noise-indicative population type assigned to that reclassified pixel, based on the noise-indicative values determined for multiple other pixels which are proximate to that reclassified pixel. Examples of ways in which classification module 230 may operate are discussed in further detail in relation to stages 520, 530, 620 and 630 of respective methods 500 and 600.

According to an embodiment of the invention, classification module 230 may be configured to assign the initial noise-indicative population types to each of the plurality of pixels irrespectively of the noise-indicative values determined for any other pixel of the inspection image.

According to an embodiment of the invention, classification module 230 is further configured to determine classification rules, prior to assigning the initial noise-indicative population types. According to such an embodiment of the invention, classification module 230 may be configured to: (a) determine the classification rules in response to the noise-indicative values of multiple pixels out of the plurality of pixels; and (b) assign the initial noise-indicative population types further based on the classification rules.

System 200 may include a type defining module (which may be part of initial classifier 232 which assigns the initial noise-indicative population types), which is configured to analyze the noise-indicative value of each of the plurality of pixels, to define different types based on the one or more noise-indicative parameters. This may be implemented, for example, by determining at least one threshold.

Classification module 230 (especially initial classifier 232, if implemented independently) may optionally be further configured to analyze the noise-indicative values of the plurality of pixels, to determine if there is more than one population of pixels (e.g. two or more noise-level distinct populations of pixels).

According to an embodiment of the invention, classification module 230 may be configured to process the at least some of the plurality of classified pixels by analyzing each pixel of at least one type of the initial noise-indicative population types, based on the noise-indicative values determined for multiple other pixels which are proximate to the respective pixel.

System 200 may include an image processing module 234 (which may be combined with posterior classification module 236), wherein the posterior classification module 236 is configured to assign the posterior noise-indicative population type to each of the reclassified pixels.

For example, the posterior classifier may do so by applying a median filter, thereby assigning to each pixel a posterior noise-indicative population type which is equal to the most common noise-indicative population type of the pixels of the kernel (while not necessarily so, this may be implemented by the image processing module).

In another example, the posterior classifier may do so by applying a closing algorithm which includes a dilation action followed by an erosion action (which may be implemented by the image processing module). Image processing module may be used, inter alia, to provide and/or generate information regarding the proximate pixels—e.g. by implementing the closing algorithm to one or more of the populations.

In yet another example, other morphological image processing algorithms may be implemented. For example, image processing module 234 may process an image in which each pixel is assigned its noise-indicative population type (as color value or otherwise), and apply a filling algorithm in which holes which are smaller of a given size (e.g. 10 pixels) are closed by assigning the pixels of the holes a posterior noise-indicative population type other than the initial noise-indicative population type formerly assigned to them. This may be implemented for example by applying blob-analysis to that image (or to part of it). The filling algorithm may be implemented for closing holes of one or more of the population types, and possibly of all of the population types.

Regardless of the exact algorithm used for determining the posterior noise-indicative population type for different pixels, the degree of proximity of the proximate pixels whose noise-indicative values are used for the determining of the posterior noise-indicative population types for respective classified pixel may vary in different embodiments of the invention. For example, in straightforward implementation of a closing algorithm, only the pixels which are in a proximity level of 1 (i.e. immediately adjacent, whether vertically, horizontally or diagonally) are considered when utilizing the noise-indicative values of the proximate pixels for determining the posterior noise-indicative population type of a given pixel.

Other degrees of proximity may also be implemented. For example, the proximity of the proximate pixels in another implementation may be limited to two pixels (i.e. for a pixel in location (X₀,Y₀), all the proximate pixels are within a square which is defined as (X₀,±2,Y₀±2)). It should be noted that the proximity degree may also be defined using a radius (e.g. the proximity of the proximate pixels from any given pixel may be limited to 5, so that the location of any proximate pixel (Xₚ,Yₚ), with respect to (X₀,Y₀) comply with a condition such as (Yₚ−Y₀)²+(Xₚ−X₀)²<5²)).

Naturally, not in all implementations, all of the pixels within a defined proximity level are used. For example, in an implementation in which the proximity level of proximate pixel proximate to each respective reclassified pixel is limited to N (e.g. N=3), then the group of all proximate pixels whose noise-indicative values are used for determining the posterior noise-indicative population type for a given pixel may exclude (in an example implementation) all of the pixels whose proximity level is 1. In some implementations, the level of proximity may be restricted differently in the X and Y directions, or in other directions or ways.

It is noted that utilizing the noise-indicative values of a larger number of proximate pixels in the determining of the posterior noise-indicative population type of a given reclassified pixel may yield more useful results (e.g. provide a distribution of pixels into noise-indicative population types which results in a higher detection rate and/or lower false detection rate) at the expense of computational complexity. Furthermore, using overly remote pixels as proximate pixels may even reduce the usability of the results in some scenarios (e.g. depending on the characteristics of the camera, the wafer, the illumination, and so on).

Referring to the example of implementing a closing algorithm, it is noted that restricting the level of proximity used directly limits the size of the holes of pixels that are closed in the closing operation. The maximal proximity level implemented (e.g. limited to proximity level of 1, 2, 3, 5 or 10) may be determined based on various parameters, e.g. based on a desired probability of detection, based on a desired false alarm rate, based on a desired ratio between the two, by a user, and so on. It is further noted that this processing (e.g. implementing the closing is not necessarily implemented in a symmetrical manner. For example, the determining of the posterior noise-indicative population type for some or all of the classified pixels may include a closing operation only in the X axis, only in the Y axis, or in different levels in the different axes (possibly also varying in different directions along a single axis). For example, at the beginning the user may indicate whether, in the given inspected area, noise classification should be corrected in the rows direction, in the columns direction, or in both directions.

Communication module 240 of system 200 is configured to provide a classification of the plurality of pixels of the inspection image into noise-indicative population types, wherein the classification of at least one reclassified pixel is based on the posterior noise-indicative population type assigned to that reclassified pixel.

As will be discussed in more detail with relation to method 600, according to an embodiment of the invention, noise estimation module 220 may be configured to analyze the part of the inspection image to determine for each of the plurality of pixels multiple noise-indicative values of multiple noise indicative parameters; wherein the classification module 230 is configured to: (a) assign to each pixel of the plurality of pixels the initial noise-indicative population type based on the multiple noise-indicative values of that pixel; (b) assign the posterior noise-indicative population type to the at least one reclassified pixel based on the multiple noise-indicative values determined for each of the multiple proximate pixels.

Optionally, system 200 may also include defects detection module 250 configured to detect defects in an inspected object that is imaged in the inspection image; wherein the defect detection module is configured to detect defects in each compared pixel of the inspection image based on a comparison of a color level of the compared pixel to the color level of a corresponding reference pixel and on the provided classification of that pixel into a noise-indicative population type. Defect detection module 250 may be part of processor 270, but may also be implemented with the help of another processor (e.g. as illustrated).

Optionally, system 200 may also include user interface 280 for the receiving of commands, for the receiving of parameters (e.g. classifying parameters, image processing parameters), and/or for the providing of information (e.g. a display, a GUI, etc.). User interface 280 may include hardware components (e.g. a display, a speaker, a keyboard, a microphone, a touch screen), software components (e.g. GUI, voice recognition software), firmware components, and any combination of the above.

System 200 may include power source 202, which is operable to provide electrical power to other hardware components of the system. For example, power source 202 may provide power to one or more of sensor 290, processor 270, and defect detection module 250. Power source 202 may be a standalone power source (e.g. a battery, an electrical generator), or connected to another power source (e.g. an electrical power regulator, connected to an alternating current outlet).

Each of the modules of the exemplified system may be implemented by software, hardware, firmware, or any combination thereof. The implementation of system 200 and of any of its modules may be achieved by a general purpose computer or processor that implements dedicated instruction, or by a dedicated hardware processor designed specifically for the tasks disclosed. The different actions of the various components may be implemented in a digital or analogous manner, or in any combination thereof.

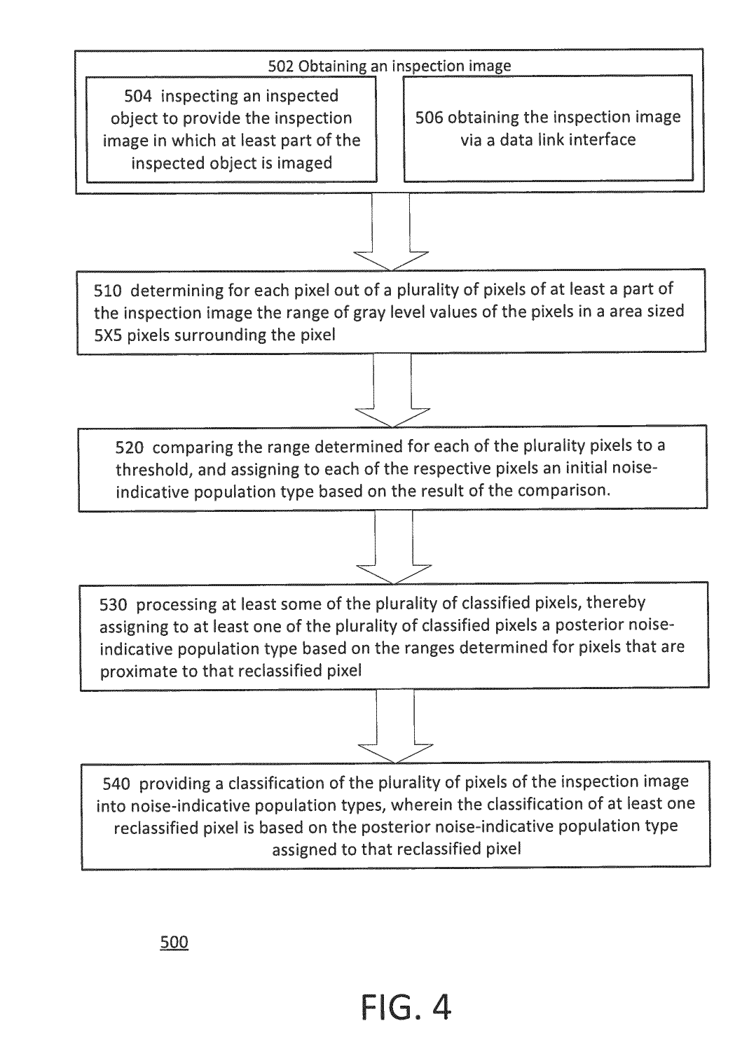

FIG. 4 illustrates computerized method 500 for classification of pixels in an inspection image into noise-indicative populations, according to an embodiment of the invention.

Method 500 may start with stage 502 of obtaining an inspection image (may be followed by providing information of the inspection image to a processor which or parts thereof, e.g. as exemplified below). Referring to the examples set forth with respect to the previous drawings, stage 502 may be carried out by an interface such as interface 210, possibly with the help of additional components (e.g. camera 290). While not necessarily so, stage 502 may include stage 504 and/or stage 506.

Stage 504 includes inspecting an inspected object to provide the inspection image in which at least part of the inspected object is imaged. While not necessarily so, the inspected object may be selected from a group consisting of an electronic circuit, a wafer, and a photomask. While the inspection image may include data of more than one inspected object (e.g. an object and its background, a group of multiple objects), for the simplicity of discussion the following description assumes that only one object is imaged. Other examples of inspection images may be aerial images taken by an airborne camera (or other type of sensor such as RADAR), images of man-made objects, medical imaging images (e.g. radiography, magnetic resonance imaging (MRI), photo acoustic imaging, ultrasonography, etc.), and so on. Referring to the examples set forth in the previous drawings, stage 504 may be carried out by a sensor such as sensor 290.

The imaged object may include different parts which are imaged with distinct noise levels (e.g. materials with different electrical conductivity that are imaged by an electron beam scanner, body parts with different penetrability to ultrasound waves used at ultrasound imaging, etc.), but this is not necessarily so. Even if the imaged object includes parts of a whole continuous spectrum of noise-inducing materials, the pixels of the inspection image may nevertheless be classified into a finite number of noise-indicative population types.

Stage 506 includes obtaining the inspection image via a data link. The inspection image may be obtained directly from the (at least one) camera or other type of sensor (e.g. electron beam scanner, RADAR, LADAR), or via an intermediary system. Referring to the examples set forth in the previous drawings, stage 506 may be carried out by an interface such as interface 210.

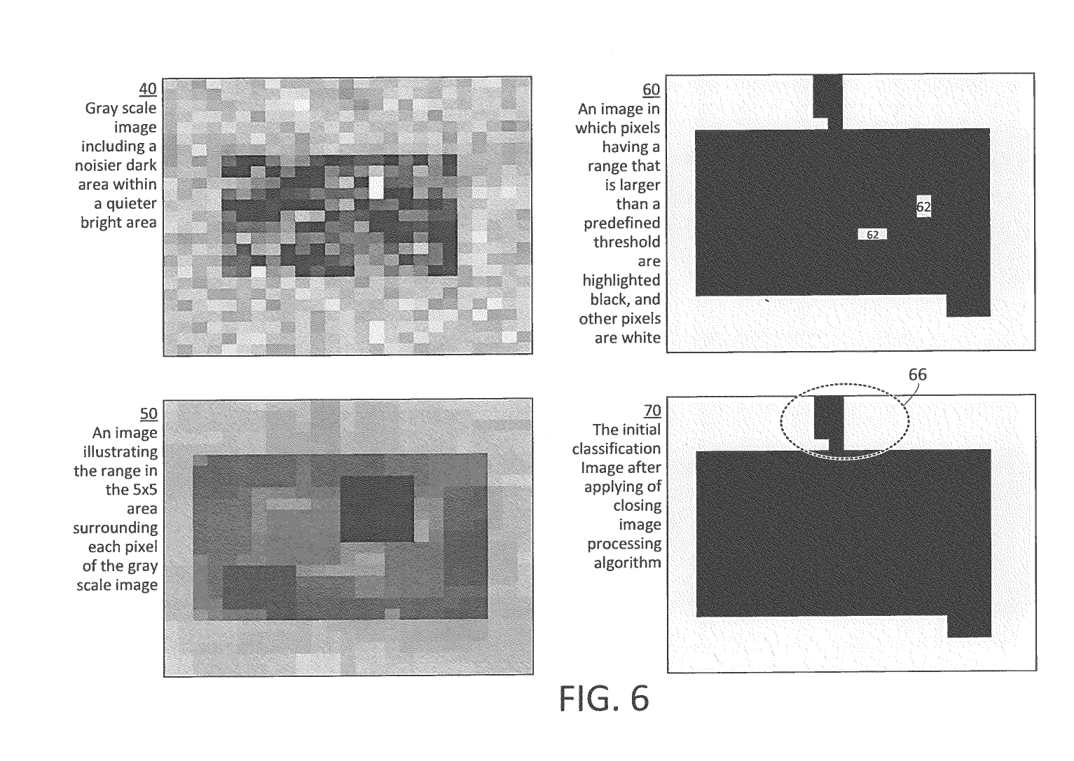

Regardless of the way in which the inspection image is generated and/or obtained, it includes color information of multiple pixels. The color information may be one dimensional (also referred to as gray level) or multi-dimensional (e.g. RGB color information). For simplicity of explanation, method 500 is exemplified using one-dimensional color information. It will however be clear to a person who is of skill in the art that the method may be extended to multi-dimensional color information, mutatis mutandis. By way of example, the inspection image may be image 40 illustrated in FIG. 6.

Each of stages 510, 520, 530, and 540 may be executed with the help of a processor. Referring to the examples set forth with respect to the previous drawings, stages 510, 520, 530 and 540 may be carried out by a processor such as processor 270, or otherwise with the help of such a processor.

Stage 510 of method 500 includes determining, for each pixel out of a plurality of pixels of the part of the inspection image, the range of gray level values of the pixels in a area sized 5 pixels by 5 pixels surrounding the pixel. The plurality of pixels may include all of the pixels of the inspection image, all of the pixels in one or more areas (e.g. in a rectangular area), and/or other distribution of pixels. The range of gray level values in the 5×5 area may be determined by subtracting the lowest gray level value of any of those 25 pixels from the highest gray level of which. This is illustrated, by way of example, in image 50 of FIG. 6. As will be discussed below in further detail (e.g. with relation to method 600), other statistical measures may be used (such as the variance of the neighboring pixels). Referring to the examples set forth in the previous drawings, stage 510 may be carried out by an analysis module such as noise estimation module 220.

The range of the gray levels of the pixels in the 5×5 kernel area is used as a noise-indicative value, indicative of the noise levels of each of the pixels. It should be noted that the darker rectangular area in the middle of image 40 was generated using thrice as large standard deviation than the lighter area around it. Since the noise levels (e.g. the standard deviation used for the generation of the illustrative image 40) may not be accessed directly, they must be accessed via an analysis of the color information of the neighboring pixels.

Color information of non-neighboring pixels may also be used in the processing of the inspection image prior to the determining of the noise-indicative values (such as the range). For example, the gray levels of some or all of the pixels in the inspection image may be normalized, spread over a wider range, or otherwise manipulated. While not necessarily so, the determination of the noise-indicative parameter, such as the range, includes a stage that depends on information of neighboring pixels but not (directly) on that of remote pixels. The kernel area in different implementations may be different from a 5×5 rectangular area.

Stage 520 of method 500 includes comparing the range determined for each of the plurality pixels to a threshold, and assigning to each of the respective pixels an initial noise-indicative population type based on the result of the comparison. The executing of stage 520 yields in a plurality of classified pixels (i.e. of pixels of the inspection image that were classified, which may also be implemented as classified pixels of a corresponding image—e.g. of an image of differences). That is—pixels whose determined range (i.e. the range of the surrounding kernel) is higher than the threshold are classified at a first initial population type indicative of estimated high noise, and pixels whose determined range is lower than the threshold are classified at a second initial population type, indicative of estimated low noise. In the example of image 60 in FIG. 6, the noisier type is marked by black pixels, and the quieter type is marked by white pixels. Referring to the examples set forth in the previous drawings, stage 520 may be carried out by a classification module such as classification module 230 (and especially by initial classification module 232).

As will be clear to a person who is of skill in the art, more than one threshold may be used to assign, to the different pixels, initial noise-indicative population types. Implementation of N range-value thresholds may be implemented to classify pixels into N+1 initial noise-indicative population types.

As can be seen in the example of FIG. 6, some of the pixels may be assigned an initial noise-indicative population type which is different from the pixels surrounding them. For example, the pixels denoted 62 are classified in the quieter noise-indicative population type, but the pixels surrounding them are classified in the noisier initial population type. Furthermore, by comparing image 60 to image 40, it can be seen that the pixels 62 belong to the darker rectangle in the middle of the image, which was generated using a significantly higher noise (higher standard deviation of normal distribution), but are nevertheless initially classified in the quieter initial population type.

The following stage 530 includes processing some or all of the plurality of pixels, thereby assigning to at least one of the plurality of classified pixels a posterior noise-indicative population type based on the ranges determined in stage 510 for pixels that are proximate to that reclassified pixel. The processing may be based directly on the ranges of those proximate pixels, but may also be based on values derived from the ranges—e.g. on a result of the comparison of stage 520. Referring to the examples set forth in the previous drawings, stage 530 may be carried out by a classification module such as classification module 230 (and especially by posterior classification module 236).

In some implementations, only pixels that belong to one or some (but not all) of the initial noise-indicative population types are reclassified. For example, in some of the implementations in which there is a binary division into a quieter and noisier initial population types, only pixels that were assigned the quieter initial population type are reclassified, but not pixels that were assigned the noisier initial population type.

For example, the assigning of a posterior population type in stage 530 may be achieved by applying a median filter, thereby assigning to each pixel a posterior noise-indicative population type which is equal to the most common noise-indicative population type of the pixels of the kernel. The median filter may be applied to one or more of the populations.

In another example, the assigning of a posterior population type in stage 530 may be achieved by implementing a processing that includes applying a closing algorithm on the one or more population types that are regarded as noisier than the type of pixels reclassified. A closing process is an image processing process that includes a stage of dilation followed by a stage of erosion. The closing of the areas of the noisier population type (or types) results in removing of pixels that were initially classified as quiet and which are isolated (alone or in a small group) within noisier pixels. Such isolated pixels—such as pixels 62 of image 60—are also referred to as “holes”.

In yet another example, other morphological image processing algorithms may be implemented. For example, image processing module 234 may process an image in which each pixel is assigned its noise-indicative population type (as color value or otherwise), and apply a filling algorithm in which such “holes” which are smaller of a given size (e.g. 10 pixels) are closed by assigning the pixels of the holes a posterior noise-indicative population type other than the initial noise-indicative population type formerly assigned to them. This may be implemented for example by applying blob-(or to part of it). The filling algorithm may be implemented for closing holes of one or more of the population types, and possibly of all of the population types.

Regardless of the exact algorithm used for determining the posterior noise-indicative population type for different pixels, the degree of proximity of the proximate pixels whose noise-indicative values are used for the determining of the posterior noise-indicative population types for respective classified pixels may vary in different embodiments of the invention. For example, in straightforward implementation of a closing algorithm, only the pixels which are in a proximity level of 1 (i.e. immediately adjacent, whether vertically, horizontally or diagonally) are considered when utilizing the noise-indicative values of the proximate pixels for determining the posterior noise-indicative population type of a given pixel.

According to an embodiment of the invention, the processing of stage 530 includes processing, with the help of the some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels. As indicated above, other restrictions on the proximity level may be implemented in different implementations of the invention.

Since the noise level of a pixel is assumed to result (at least partly) from the imaged subject, it may be assumed that a single quiet pixel amidst noisier pixels does not result from the physical subject imaged but rather from a statistical error and/or measurement error, and therefore such a pixel may be classified at a noisier initial population type, based on the noise-indicative values of the pixels surrounding it.

It should be noted that some of the pixels of the original image that originate in a quiet area of the object (e.g. of the wafer) are classified as belonging to a noisier population type even after the reclassification (e.g. the pixels denoted 66). However, erring in the classification of pixels on the side of misclassifying pixels as noisier than they actually are has much lesser implications in some implementations, e.g. as discussed below.

Stage 530 may be followed by stage 540 of providing a classification of the plurality of pixels of the inspection image into noise-indicative population types, wherein the classification of at least one reclassified pixel is based on the posterior noise-indicative population type assigned to that reclassified pixel. Referring to the examples set forth in the previous drawings, stage 540 may be carried out by a communication module such as communication module 240.

Similarly to method 600 discussed below, the providing of the classification may be followed by various actions that are based on that classification, such as defect detection.

Method 500 discussed above may be generalized in various ways. For example, the classification of pixels may be based on multi-dimensional color information, on statistical metrics other than range, and so on. Also, the classification (whether the initial and/or the posterior) may be based on multiple parameters—noise-indicative parameters, but possibly also other parameters.

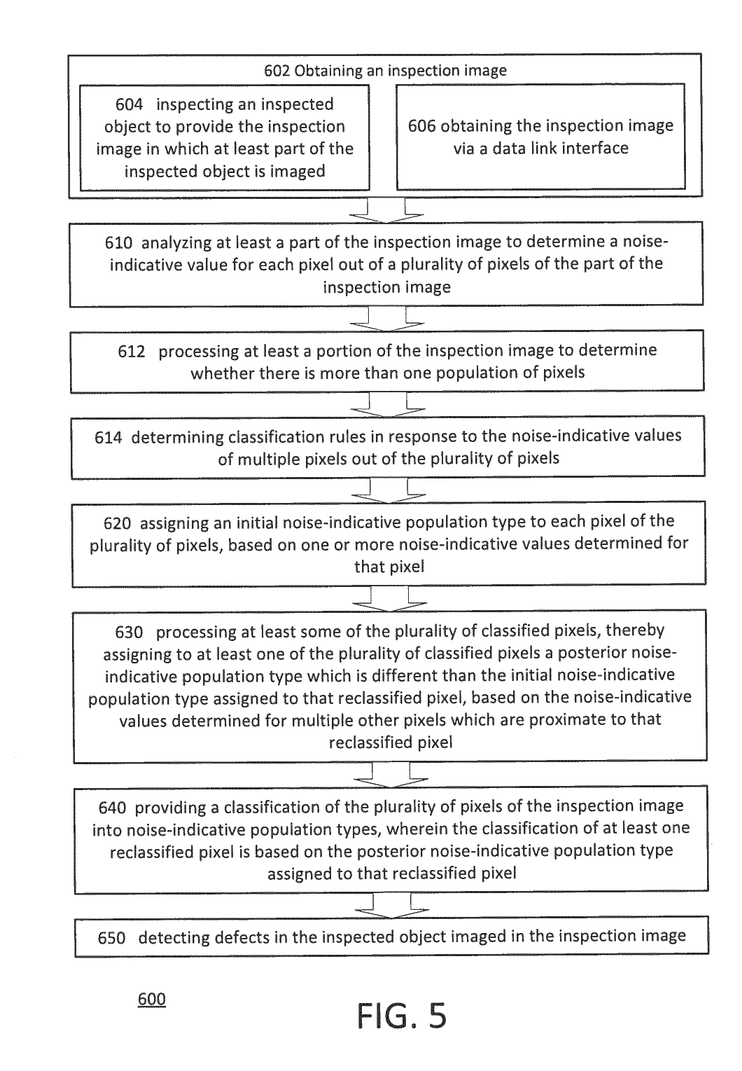

FIG. 5 illustrates computerized method 600 for classification of pixels in an inspection image into noise-indicative populations, according to an embodiment of the invention. In a sense, method 500 is a private case of method 600. In such a sense, stage 510 may be considered a private case of the corresponding stage 610, stage 520 a private case of the corresponding stage 620, and so on. Referring to the examples set forth in the previous drawings, method 600 may be carried out by a system such as system 200.

Each of stages 610-640, as well as stage 650, may be executed with the help of a processor. Referring to the examples set forth with respect to the previous drawings, these stages may be carried out by a processor such as processor 270 (and/or defect detection module 250), or otherwise with the help of such a processor.

Method 600 may start with stage 602 of obtaining an inspection image (may be followed by providing information of the inspection image to a processor which processes that image or parts thereof, e.g. as exemplified below). Referring to the examples set forth with respect to the previous drawings, stage 502 may be carried out by an interface such as interface 210, possibly with the help of additional components (e.g. camera 290). While not necessarily so, stage 502 may include stage 504 and/or stage 506

Stage 604 includes inspecting an inspected object to provide the inspection image in which at least part of the inspected object is imaged. While not necessarily so, the inspected object imaged in the inspection image may be selected from a group consisting of an electronic circuit, a wafer, and a photomask. The various alternatives of inspection images and inspection object discussed with relation to method 500 may also be implemented with respect to method 600. Referring to the examples set forth in the previous drawings, stage 604 may be carried out by a sensor such as sensor 290.

Stage 606 includes obtaining the inspection image via a data link. The inspection image may be obtained directly from the (at least one) camera or other type of sensor (e.g. electron beam scanner, RADAR, LADAR), or via an intermediary system. Referring to the examples set forth in the previous drawings, stage 606 may be carried out by a communication interface such as interface 210.

Regardless of the way in which the inspection image is generated and/or obtained, it includes color information of multiple pixels. The color information may be one dimensional (also referred to as gray level) or multi-dimensional (e.g. RGB color information). By way of example, the inspection image may be image 40 illustrated in FIG. 6.

It is noted that inspection images of different sizes may be implemented in different implementations of the invention. For example, while the size of the inspection image may be of the order of magnitude of 1^{x}10³ by 1^{x}10³ pixels, images that are significantly smaller (e.g. of the order of magnitude of 1^{x}10² by 1^{x}10²) or significantly larger (e.g. of the order of magnitude of 1^{x}10⁵ by 1^{x}10⁷) may be processed just as well. Method 600 may also include selecting the inspection image processed in the method out of a larger image, e.g. based on user definitions.

Stage 610 of method 600 includes analyzing at least a part of the inspection image to determine a noise-indicative value for each pixel out of a plurality of pixels of the part of the inspection image. In the corresponding stage 510 of method 500, the result of the analyzing was the range of gray-level values in the 5×5 kernel area surrounding each pixel (i.e. the difference between the maximal gray level in that area and the minimal one). Referring to the examples set forth in the previous drawings, stage 610 may be carried out by an analysis module such as noise estimation module 220.

In stage 610, other noise-indicative parameters may be calculated for the different pixels, instead of or in addition to the range. For example, the statistical variance of the gray levels of the pixels in the kernel may be determined (i.e. the average of the squared differences of the GL of the different pixels of the kernel from the mean GL in that kernel). In but a few examples, some of the possible kinds of noise-indicative parameters which may be used, apart from range and variance, are directional variance (e.g. VARₓ, VAR_{y}), a local derivative of variance, local entropy, standard deviation, and so on. If the color information is a multidimensional color information (e.g. RGB color information), the levels in the different channels (e.g. RED channel, GREEN channel and BLUE channel) may be processed independently (e.g. variance of RED levels in the kernel) or in connection to one another.

Other parameters, which are not necessarily noise-indicative, may also be calculated for different pixels, in addition to the one or more noise-indicative parameters. For example, the average, median, or highest likelihood gray level of all of the pixels in the kernel may be determined (e.g. for especially looking for defects in dark areas of the image).

The analyzing of stage 610 may include determining for each analyzed pixel out of the plurality of pixels a value of a distribution-indicative parameter, which is responsive to color-levels of pixels in a predetermined-sized environment of that analyzed pixel. The distribution-indicative parameter may give an indication of the way in which the color levels of the pixels in the predetermined-size environment (e.g. the 5×5 kernel) are distributed. The set of those analyzed pixels may be a proper subset of the plurality of pixels, or identical thereto.

It should be noted that the inspection image may or may not include pixels of multiple noise populations (for example, the entire area imaged may be scanned in a noisy inspection). Therefore, method 600 may optionally include stage 612 of processing at least a portion of the inspection image to determine whether there is more than one population of pixels (e.g. two or more noise-level distinct populations of pixels). This may be implemented, for example, based on an analysis of the noise-indicative values determined for each of the plurality of pixels in stage 610.

Considering a histogram of the noise-indicative values of the pixels in the inspection image (e.g. as illustrated in FIGS. 2A and 2B), the number of distinctive peaks (two in each of FIGS. 2A and 2B) may correspond to the number of noise-level-populations. Stage 612 (as well as some of the following stages) may be based on a histogram of VAR levels (or another noise-indicative parameter) of each of the pixels, but this is not necessarily so. Referring to any of the stages that process noise-indicative values, prior to that processing the determined noise-indicative values may be grouped and processed as groups, but not necessarily so.

It should be noted that while the method may be implemented using a noise-indicative parameter such as variance, other parameters may also be used, in which case the classification of pixels into multiple population types may not be noise-indicative (or, less strictly, indicative of other characteristics apart from noise). Furthermore, more than a single parameter (whether noise-indicative or not) may be implemented, in which case multiple such histograms may be used.

Optionally, if there is only one population (or multiple populations which do not qualify to some decision rules), method 600 may be discontinued.

In stage 620 which is discussed below, each of the plurality of pixels is assigned an initial noise-indicative population type, based on its noise-indicative value. The executing of stage 620 yields in a plurality of classified pixels (i.e. of pixels of the inspection image that were classified, which may also be implemented as classified pixels of a corresponding image—e.g. of an image of differences). The assigning of the initial noise-indicative population type may be based on classification rules which may be predetermined, but may also be determined as part of method 600.

Optional stage 614 which, if implemented, precedes stage 620, includes determining classification rules in response to the noise-indicative values of multiple pixels out of the plurality of pixels. That is, the classification rules on which the assigning of the initial noise-indicative population types (based on the noise-indicative values of the analyzed pixel) in stage 520 is based are themselves based on the noise-indicative values of some or all of the plurality of pixels.

Referring to the one-dimensional example which is exemplified in FIGS. 2A, 2B, and 6, and assuming that the noise-indicative parameter is variance, stage 614 may include determining a variance level threshold (or several thresholds), based on the variance values determined for each of the plurality of pixels. For example, the threshold may be determined in the local minimum between two peaks (e.g. as exemplified in FIG. 2A), but may also be determined otherwise.

If more than one parameter is used, one or more thresholds may be determined for each of these parameters. Since the thresholds are used to define different initial population types, in cases in which population types are defined based on more than one parameter, the assigning of population types in stage 620 may be based on classification rules other than one-dimensional thresholds.

In an example, multidimensional threshold based classification rules may be “a pixel belongs to population type A if the variance of pixels in the 5×5 kernel surrounding it is lower than 10, and the average gray level in that kernel is higher than 80”. A multidimensional classification rule that is not based on one-dimensional thresholds is “a pixel belongs to population type B if the variance of the pixel in the kernel surrounding it is higher than 10% of the average GL in that kernel”.

While in some implementations a pixel may be assigned more than a single initial noise-indicative population type, in the following discussion it is assumed that each of the plurality of pixels is assigned only a single noise-indicative population-type. The different noise-indicative population types may be well-ordered (at least in principle, since some noisy pixels may be erroneously classified in quiet types, and vice versa), but not necessarily so. The terms “noisier population type” and “quieter population type” may apply in instances in which the population types are well ordered, but also in other situations.

Stage 620 of method 600 includes assigning an initial noise-indicative population type to each pixel of the plurality of pixels, based on one or more noise-indicative values determined for that pixel in stage 610. The executing of stage 620 yields a plurality of classified pixels (i.e. of pixels of the inspection image that were classified, which may also be implemented as classified pixels of a corresponding image—e.g. of an image of differences). This may be done, for example, based on a comparison of the one or more noise-indicative values determined for that pixel to one or more thresholds, but other techniques may also be implemented. Referring to the examples set forth in the previous drawings, stage 620 may be carried out by a classification module such as classification module 230 (and especially by initial classification module 232).

It should be noted that the assigning of the initial noise-indicative population type to each of the plurality of pixels in stage 620 may be carried out irrespectively of the noise-indicative values determined for any other pixel of the inspection image. That is, contrary to the reclassifying of stage 630 which is responsive to the noise-indicative values of neighboring pixels, in such implementations of stage 620 the assigning in stage 620 is irrespective of such values of neighboring (or other) pixels.

In the example of FIGS. 2A, 2B and 6 there is only one threshold, and therefore only two initial noise-indicative population types—a quiet population type and a noisy population type. It will be clear to a person who is of skill in the art that (in one dimensional classification which is based only a single noise-indicative parameter), N thresholds may be implemented (N>1) to classify pixels into N+1 initial noise-indicative population types.

Stage 630 of method 600 includes processing at least some the plurality of classified pixels (such pixels are referred to as “reclassified pixels”), by assigning to at least one of the plurality of classified pixels a posterior noise-indicative population type, which is selected based on the noise-indicative values determined (e.g. in stage 610, but not necessarily at this stage) for multiple other pixels which are proximate to that reclassified pixel. It should be noted that, like the noise-indicative value of the reclassified pixel, the noise-indicative values of each of the other pixels is defined based on color information of multiple pixels. Referring to the examples set forth in the previous drawings, stage 630 may be carried out by a classification module such as classification module 230 (and especially by posterior classification module 236).

The reclassifying includes assigning to the each of the reclassified pixels a posterior noise-indicative population type that is different than the initial noise-indicative population type assigned to that reclassified pixel. It is however noted that the reclassification of those reclassified pixels in stage 630 may be a part of re-evaluating the noise-indicative population type to which other (non-reclassified) pixels of the inspection image belong, where the result of this re-evaluation for the non-reclassified pixels is that those pixels should not be assigned a posterior noise-indicative population type different than the initial one assigned to them in stage 620.

The re-evaluation (if implemented) and the processing may be applied to all of the plurality of the pixels, or only to one or more proper subsets of the plurality of pixels. For example, the re-evaluation (if implemented) and the processing may be applied only to pixels that were assigned (at stage 620) some of the initial noise-indicative population type, but not to pixels which were assigned other initial noise-indicative population types.

Optionally, the processing is a result of an analysis of each pixel of at least one type of the initial noise-indicative population types, based on the noise-indicative values determined for multiple other pixels which are proximate to the respective pixel.

Assuming that the initial noise-indicative population types are ordered (e.g. in a well-order, but possibly also in less strict orders such as a partial order), in some implementations the re-evaluation (if implemented) and the processing are applied only to pixels that were assigned the quieter initial noise-indicative population types, but not to pixels that were assigned a noisier initial noise-indicative population type (if a quieter noise-indicative population type exists).

It should be noted that the set of all posterior noise-indicative population types which may be assigned to pixels of the inspection image may be identical to the set of initial noise-indicative population types, but this is not necessarily so. In an example, there may be four initial noise-indicative population types, but five posterior noise-indicative population types. While the initial noise-indicative population types may be defined only by the aforementioned classification rules which are based on the (at least one) noise-indicative parameter determined for each single pixel, such definitions do not apply to the posterior noise-indicative population types. An example, in which the posterior noise-indicative population types are the same as the initial noise-indicative population types, is a set of two noise-indicative population types, wherein each pixel may only be classified in one of them (e.g. “noisier” and “quieter” pixels).

In some implementations, a posterior noise-indicative population type is assigned only to the pixels of the quietest type (which means that those pixels can only be posteriorly classified at a noisier type). It is however noted that in other implementations, pixels of more than one initial noise-indicative population type—and possibly even pixels of the noisiest type—may be analyzed for determination of a posterior noise-indicative population type. Likewise, it is noted that in other implementations, pixels classified in a given initial noise-indicative population type may be assigned a quieter posterior noise-indicative population type.

The posterior noise-indicative population type assigned to each pixel may be determined in different manners, in different implementations of the invention. For example, the posterior noise-indicative population type of a given pixel may be determined based on the noise-indicative values of all 8 immediately adjacent pixels (including diagonally adjacent pixels).

The determination of the posterior noise-indicative population type may depend directly on the noise-indicative values of the proximate pixels (e.g. VAR or range levels determined for which), but may also depend on a derivative parameter which in turn depends on those noise-indicative values. Especially, the posterior noise-indicative population type of a given pixel may depend on the initial noise-indicative population type of the proximate pixel (and possibly also of the pixel itself).

The assigning of a posterior population type may be implemented in various ways. For example, it may be achieved by implementing a closing algorithm on the one or more of the noise-indicative population types. It is noted that a closing process is an image processing process that includes a stage of dilation followed by a stage of erosion. Especially, the re-evaluation of a pixel of a given noise-indicative population type may depend on the result of a closing algorithm applied for one or more noise-indicative population types that are noisier than the given noise-indicative population type.

The closing of the areas of the one or more noise-indicative population types (e.g. the noisier type or types) results in removing of holes of pixels initially classified at another noise-indicative population type (e.g. at a quieter noise-indicative population type). Since the noise-level of a pixel is assumed to result (at least partly) from the imaged subject (the inspected object), it may be assumed that a single quiet pixel amidst noisier pixels does not result from the physical inspection object imaged, but rather from a statistical error and/or measurement error. Accordingly, such a pixel may be classified at a noisier noise-indicative population type than its initial classification, based on the noise-indicative population type of the pixels surrounding it.

An example of the applying of a closing algorithm is illustrated in FIG. 6, wherein image 70 is a result of a closing algorithm applied to the noise-indicative population type denoted by black pixels. The applying of the closing algorithm in the illustrated example results in the diminishing of the holes 62.

The size of the holes of pixels that are closed in the closing operation may be determined based on various parameters, e.g. based on a desired probability of detection, based on a desired false alarm rate, based on a desired ratio between the two, by a user, and so on.

It is noted that the closing is not necessarily implemented in a symmetrical manner. For example, the re-evaluation may include a closing operation only in the X axis, only in the Y axis, or in different levels in the different axes (possibly also varying in different directions along a single axis). For example, at the beginning the user may indicate if in the given inspected area noise classification should be corrected in the rows direction, in the columns direction, or in both directions.

It is further noted that the closing operation, if implemented, may be implemented for closing areas which are not rectangular. For example, the closing operation may be used for ignoring holes which include a predefined shape (e.g. a given ellipse), and closing holes in which the predefined shape may not be included.

Stage 640 of method 600 includes providing a classification of the plurality of pixels of the inspection image into noise-indicative population types, wherein the classification of at least one reclassified pixel is based on the posterior noise-indicative population type assigned to that reclassified pixel. At least some of the pixels may be classified in the provided classification based on the posterior noise-indicative population type assigned to them, which is different than the initial noise-indicative population type assigned to them. Referring to the examples set forth in the previous drawings, stage 540 may be carried out by a communication module such as communication module 240.

The classification provided may include information of the noise-indicative population type assigned to each of the plurality of pixels, but may also include another classification which is based on the noise-indicative population type assigned. For example, even if the set of initial noise-indicative population types includes four types, and the set of posterior noise-indicative population types includes six types, the classification provided in stage 640 may be based on a set of a different number of classes.

Also, the classification provided may be based on other classifications which result from processing of the inspection image. For example, pixels may be classified based on their gray level, based on the dominant field (e.g. black field or gray field, as implemented in inspection of wafers), on the relation of the gray level of the pixels to surrounding pixels (e.g. valley, mountain, etc.), and so on. The classification provided may be based on such other classifications, which do not pertain to noise.

The classification provided in stage 640 may be saved to a database (wholly or partly), communicated to an external system (e.g. via a dedicated data link), displayed or otherwise presented to a human user, and so on. As discussed below, the classification provided in stage 640 may also be used for additional processing of the data generated, and possibly for actions based on such processing (e.g. manipulation of the inspected object, classification of the inspected object, and so on).

For example, method 600 may include stage 650 of detecting defects in an inspected object that is imaged in the inspection image; wherein the detecting of the defects in each compared pixel of the inspection image is based on the provided classification of that pixel into a noise-indicative population type, and possibly also on a comparison of a color level of the compared pixel to the color level of a corresponding reference pixel. The corresponding reference pixel may be another pixel in the inspection image, but may also be a reference in another inspection image or another reference data (e.g. computer aided design—CAD—information). Referring to the examples set forth in the previous drawings, stage 650 may be carried out by a defect detection module such as defect detection module 250.

It is noted that the method may further include a stage of analyzing the inspected image for defect detection (e.g. by comparing it to an inspected image of a parallel area in another die or in another cell), wherein the defect detection in at least some of the pixels is based on the posterior classification. For example, a different threshold may be determined for each of the provided classification classes, and the gray level differences between corresponding pixels of the two images are compared to the respective threshold, to determine whether that pixel includes a potential defect or not.

Instead or in addition to the defect detection, method 600 may also include a stage of inspecting one or more parts of the inspected object with a different inspection system than the one used for the obtaining of the inspection image (or the same system, using different parameters that enable improved accuracy of inspection), based on the provided classification results.

Instead or in addition to the defect detection, method 600 may also include a stage of manipulating one or more parts of the inspected object based on the provided classification results. For example, the manipulating may include etching some parts of the inspection object, drilling some parts of the inspection object, welding some parts of the inspection object, transmitting electromagnetic waves toward some parts of the inspection object, and so on.

Referring again to method 600 as a whole, it is again noted that method 600 may implement more than a single kind of noise-indicative parameter. According to such an implementation, the analyzing of stage 610 may include analyzing the part of the inspection image to determine for some or all of the plurality of pixels multiple noise-indicative values of multiple noise indicative parameters. Likewise, the assigning of the initial noise-indicative population type to each pixel of the plurality of pixels in stage 620 may be based on the multiple noise-indicative values of that pixel. Also, the reclassifying of stage 630 may include assigning the posterior noise-indicative population type to the at least one reclassified pixel based on the multiple noise-indicative values determined for each of the multiple proximate pixels.

Referring to system 200 and to methods 500 and 600, and further referring to the examples of FIGS. 2A, 2B and 6, it is noted that the proposed systems and methods may be used to classify pixels of the inspection image as belonging to a quiet noise-indicative population type, only for such pixels that belong to an area that is larger than one pixel, and which fulfills some spatial requirements (e.g. minimal size, minimal height, minimal width, etc.).

Pixels whose noise-indicative value suggests a quiet noise-level but which are nevertheless isolated amidst noisy environments are not classified—in such implementations of the invention—as belonging to a quiet noise-indicative population type but rather belonging to a noisy one. Even if such a pixel is indeed a quiet pixel, erring on the side of classifying a quiet pixel as noisy ones still does not incur false detection.

The classifying of pixels as a posterior noise-indicative population type which is noisier than the initial noise class of those pixels decreases the number of noisy pixels which are erroneously included in quieter population types, and which were initially classified in the quieter population type due to insufficiency of the noise-indicative value of the single pixel as a sole classifying criterion.

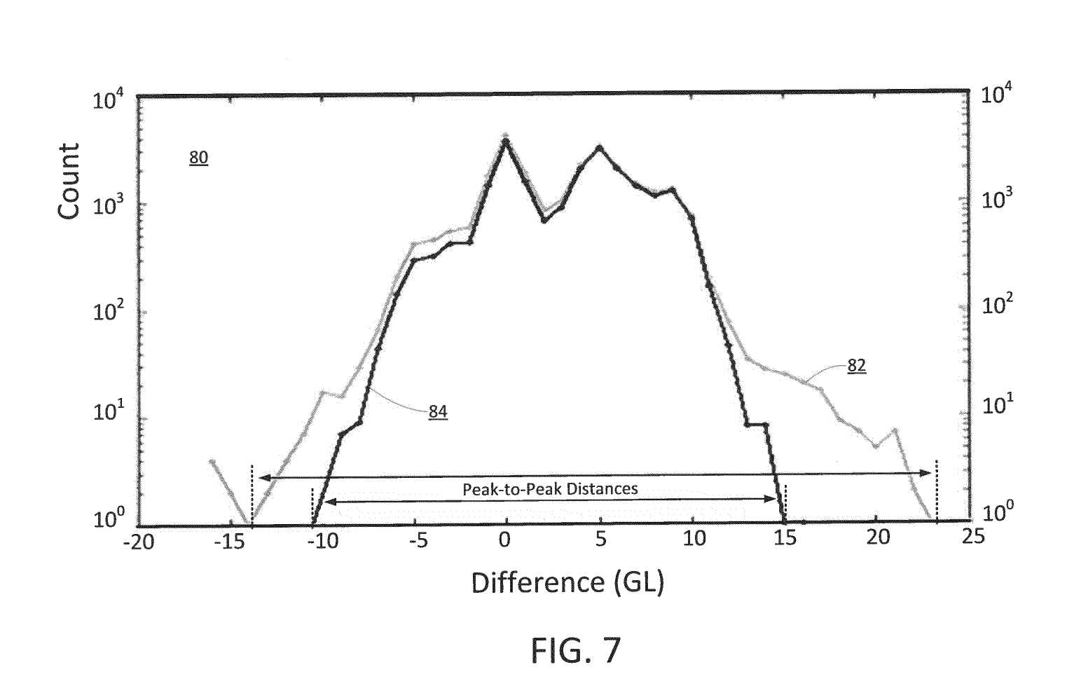

FIG. 7 includes graph 80 which includes histograms 82 and 84 of the differences in the gray level (GL) values between the inspection image and a reference image (e.g. of two dies in a Die to Die inspection), according to an embodiment of the invention. The histograms show the count of pixels classified only in the quiet population type in the imaged area.

Histogram 82 shows the number of pixels for various differences between the gray level of a pixel of the inspection image to a respective pixel of the reference image, as obtained for the quietest population type in a classification based on the noise-indicative value of each pixel (and not of neighboring pixels as well).

Histogram 84 on the other hand shows the number of pixels for various differences between the gray level of a pixel of the inspection image to a respective pixel of the reference image, as obtained for the quietest posterior noise-indicative population type in a classification based on the noise-indicative value of neighboring pixels (in an implementation including a closing operation as discussed above).

The peak-to-peak distance of histogram 84—some 26 gray-level units—is much smaller than the corresponding peak-to-peak distance of histogram 82—some 37 GL units. In absolute values, the zero-to-peak distance of histogram 84 is 15 GL units, compared to some 23 GL units. That is, the gray levels of the vast majority of pixels classified as quiet in the classification system of histogram 84 are within 15 GL units of the corresponding reference pixels. In the classification system used for the classification of histogram 82 in comparison, a distance of 23 GL units is required to count for a similar ratio of pixels.

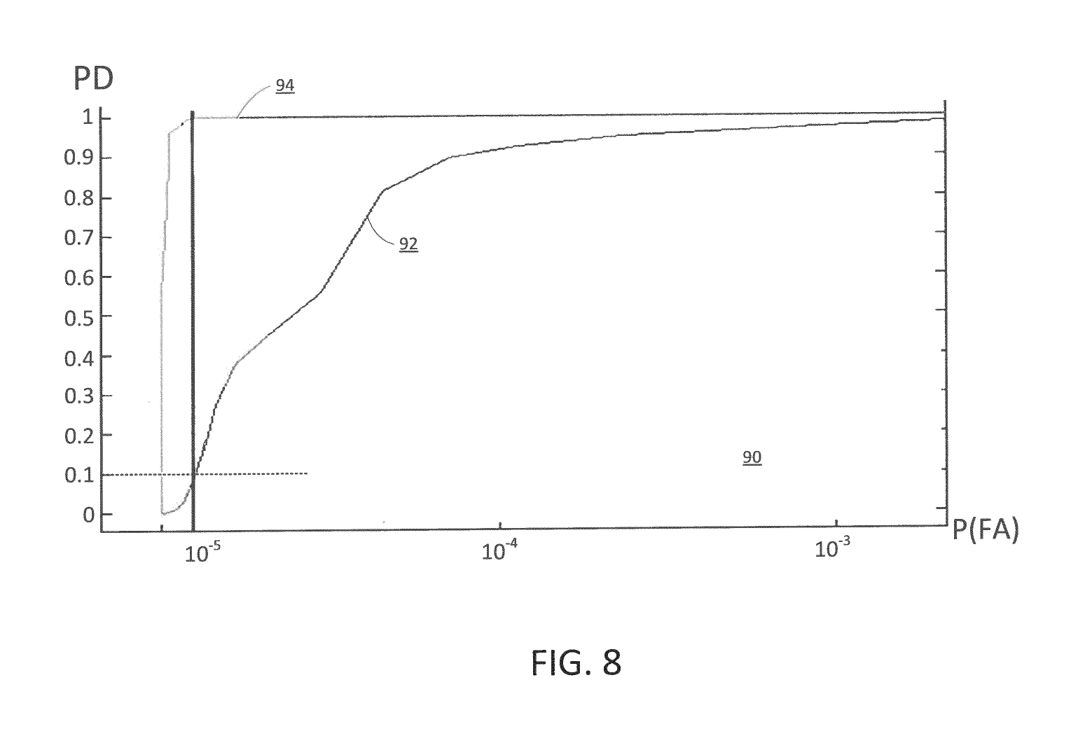

The lowering of the pick-to-pick distance means, for example, that a lower threshold may be selected for defect detection in pixels of the quieter population type in the comparison between the inspection image and the reference image. Likewise, more defects may be detected using the disclosed methods and systems, without increasing the false alarm rate (FAR), as can be seen in FIG. 8.

FIG. 8 illustrates a comparison between defect detection enabled by the proposed systems and methods (curve 94) and between defect detection enabled by classification of pixels based on the noise-indicative value of each pixel (and not of neighboring pixels, curve 92), according to an embodiment of the invention. The comparison of FIG. 8 is presented on a PD (Pfa) chart, in which the probability of detection (of a defect) is provided as a function of the probability of false alarm rate.

While relatively high probability of detection may be achieved in both of such techniques, the false alarm rate in which this is enabled is very different. In the illustrated example, in false alarm rate of 10⁻⁵, classification based only on the noise-indicative value of each pixel (and not of neighboring pixels) enables detection of less than 10% of the defects, while implementation of the proposed method 600 enables detection of almost 100% of all defects.

Referring to an implementation of the disclosed techniques for detection of defects in wafers during manufacture thereof, it is noted that high false alarm rate is intolerable. The amount of pixels inspected and analyzed every second is enormous, and therefore the number of possible defects that may be analyzed is limited by the time constrains defined for the manufacturing process. As can be seen, the proposed techniques of re-classifying pixels based on the noise-indicative values of neighboring pixels provides a significantly higher detection rate for any false alarm rate selected.

The utilization of methods 500 and 600 (e.g. in systems such as system 200) also enables saving computational power—as the number of pixels defined as potential defects is significantly smaller when compared to the prior art, and therefore a smaller number of processing units is required to analyze those potential defects.

It should be noted that according to an embodiment of the invention, the proposed method may be implemented in a tangible computer readable medium having a computer readable code embodied therein for the carrying out of that method, wherein the computer readable code includes instructions which may be executed by one or more processors, for executing the different stages of the method.

It is noted that any one of methods 500 and 600 may be implemented by execution of a corresponding program of instructions, which is tangibly embodied on a program storage device which is readable by machine (such as the one executing the corresponding methods, or parts thereof). For example, in accordance with an aspect of the presently disclosed subject matter, there is yet further provided a program storage device readable by machine, tangibly embodying a program of instructions executable by the machine to perform method for classification of pixels in an inspection image into noise-indicative populations including the steps of: (a) analyzing at least a part of the inspection image to determine a noise-indicative value for each pixel out of a plurality of pixels of the part of the inspection image; (b) assigning an initial noise-indicative population type to each pixel of the plurality of pixels based on the noise-indicative value of that pixel, thus yielding a plurality of classified pixels; (c) processing at least some of the plurality of classified pixels, thereby assigning to at least one of the plurality of classified pixels a posterior noise-indicative population type which is different from the initial noise-indicative population type assigned to that reclassified pixel, based on the noise-indicative values determined for multiple other pixels which are proximate to that reclassified pixel; and (d) providing a classification of the plurality of pixels of the inspection image into noise-indicative population types, wherein the classification of at least one reclassified pixel is based on the posterior noise-indicative population type assigned to that reclassified pixel.

It should be noted that the program of instructions may include instructions which corresponds to each of the stages of method 500 (and wherein execution of those instructions by the machine results in execution of a corresponding stages of method 500), even if not explicitly elaborated.

In accordance with an embodiment of the presently disclosed subject matter, the instructions included in the program of instructions for the step of processing may include instructions for processing the at least some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels.

In accordance with an embodiment of the presently disclosed subject matter, the instructions included in the program of instructions for the step of assigning may include instructions for assigning the initial noise-indicative population type to each of the plurality of pixels irrespective of the noise-indicative values determined for any other pixel of the inspection image.

In accordance with an embodiment of the presently disclosed subject matter, the program of instructions may include instructions for determining classification rules in response to the noise-indicative values of multiple pixels out of the plurality of pixels; wherein the assigning of the initial noise-indicative population type is further based on the classification rules.

In accordance with an embodiment of the presently disclosed subject matter, the instructions included in the program of instructions for the step of analyzing may include instructions for determining for each analyzed pixel out of the plurality of pixels a value of a distribution-indicative parameter that is responsive to color-levels of pixels in a predetermined-sized environment of that analyzed pixel.

In accordance with an embodiment of the presently disclosed subject matter, the instructions included in the program of instructions for the step of analyzing may include instructions for analyzing the part of the inspection image to determine for each of the plurality of pixels multiple noise-indicative values of multiple noise indicative parameters; wherein the assigning of the initial noise-indicative population type to each pixel of the plurality of pixels is based on the multiple noise-indicative values of that pixel; and wherein the processing including assigning the posterior noise-indicative population type to the at least one reclassified pixel based on the multiple noise-indicative values determined for each of the multiple proximate pixels.

In accordance with an embodiment of the presently disclosed subject matter, the processing may be a result of an analysis of each pixel of at least one type of the initial noise-indicative population types, based on the noise-indicative values determined for multiple other pixels which are proximate to the respective pixel.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A computerized system for classification of pixels in an inspection image into noise-indicative populations, the system comprising:
an interface operable to obtain an inspection image and to provide information of the inspection image to a processor coupled thereto; and
the processor, comprising:
a noise estimation module, configured to analyze at least a part of the inspection image to determine a noise-indicative value for each pixel out of a plurality of pixels of the part of the inspection image; and
a classification module configured to:
(a) assign an initial noise-indicative population type to each pixel of the plurality of pixels based on the noise-indicative value of that pixel, thus yielding a plurality of classified pixels;
(b) process at least some of the plurality of classified pixels, thereby assigning to at least one of the plurality of reclassified pixels a posterior noise-indicative population type which is different from the initial noise-indicative population type assigned to that reclassified pixel, based on the noise-indicative values determined for multiple other pixels which are proximate to that reclassified pixel; and
(c) provide a classification of the plurality of pixels of the inspection image into noise-indicative population types, wherein the classification of at least one reclassified pixel is based on the posterior noise-indicative population type assigned to that reclassified pixel.

2. The system according to claim 1, wherein the inspected image is a result of an inspection of an inspected object which is selected from a group consisting of an electronic circuit, a wafer, and a photomask.

3. The system according to claim 1, wherein the classification module is configured to assign the initial noise-indicative population types to each of the plurality of pixels irrespective of the noise-indicative values determined for any other pixel of the inspection image.

4. The system according to claim 1, wherein the classification module is further configured to determine classification rules, prior to assigning the initial noise-indicative population types, wherein the classification module is configured to: (a) determine the classification rules in response to the noise-indicative values of multiple pixels out of the plurality of pixels; and (b) assign the initial noise-indicative population types further based on the classification rules.

5. The system according to claim 1, wherein the noise estimation module is configured to determine for each analyzed pixel out of the plurality of pixels a value of a distribution-indicative parameter that is responsive to color-levels of pixels in a predetermined-sized environment of that analyzed pixel.

6. The system according to claim 1, wherein the noise estimation module is configured to analyze the part of the inspection image to determine for each of the plurality of pixels multiple noise-indicative values of multiple noise indicative parameters;
wherein the classification module is configured to: (a) assign to each pixel of the plurality of pixels the initial noise-indicative population type based on the multiple noise-indicative values of that pixel; and (b) assign the posterior noise-indicative population type to the at least one reclassified pixel based on the multiple noise-indicative values determined for each of the multiple proximate pixels.

7. The system according to claim 1, wherein the classification module is configured to process the at least some of the plurality of classified pixels by analyzing each pixel of at least one type of the initial noise-indicative population types, based on the noise-indicative values determined for multiple other pixels which are proximate to the respective pixel.

8. The system according to claim 1, further comprising a defects detection module configured to detect defects in an inspected object that is imaged in the inspection image; wherein the defect detection module is configured to detect defects in each compared pixel of the inspection image based on a comparison of a color level of the compared pixel to the color level of a corresponding reference pixel and on the provided classification of that pixel into a noise-indicative population type.

9. A computerized method for classification of pixels in an inspection image into noise-indicative populations, the method comprising:
analyzing with the help of a processor at least a part of the inspection image to determine a noise-indicative value for each pixel out of a plurality of pixels of the part of the inspection image;
assigning with the help of the processor an initial noise-indicative population type to each pixel of the plurality of pixels based on the noise-indicative value of that pixel, thus yielding a plurality of classified pixels;
processing, with the help of the processor, at least some of the plurality of classified pixels, thereby assigning to at least one of the plurality of classified pixels a posterior noise-indicative population type which is different from the initial noise-indicative population type assigned to that reclassified pixel, based on the noise-indicative values determined for multiple other pixels which are proximate to that reclassified pixel; and
providing with the help of the processor a classification of the plurality of pixels of the inspection image into noise-indicative population types, wherein the classification of at least one reclassified pixel is based on the posterior noise-indicative population type assigned to that reclassified pixel.

10. The method according to claim 9, wherein the inspected image is a result of an inspection of an inspected object which is selected from a group consisting of an electronic circuit, a wafer, and a photomask.

11. The method according to claim 9, wherein the processing comprises processing with the help of the processor the at least some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels.

12. The method according to claim 9, wherein the assigning of the initial noise-indicative population type to each of the plurality of pixels is irrespective of the noise-indicative values determined for any other pixel of the inspection image.

13. The method according to claim 9, wherein the assigning of the initial noise-indicative population types is preceded by determining classification rules in response to the noise-indicative values of multiple pixels out of the plurality of pixels; wherein the assigning of the initial noise-indicative population type is further based on the classification rules.

14. The method according to claim 9, wherein the analyzing comprises determining for each analyzed pixel out of the plurality of pixels a value of a distribution-indicative parameter that is responsive to color-levels of pixels in a predetermined-sized environment of that analyzed pixel.

15. The method according to claim 9, wherein the analyzing comprises analyzing the part of the inspection image to determine for each of the plurality of pixels multiple noise-indicative values of multiple noise indicative parameters;
wherein the assigning of the initial noise-indicative population type to each pixel of the plurality of pixels is based on the multiple noise-indicative values of that pixel; and
wherein the processing comprises assigning the posterior noise-indicative population type to the at least one reclassified pixel based on the multiple noise-indicative values determined for each of the multiple proximate pixels.

16. The method according to claim 9, wherein the processing is a result of an analysis of each pixel of at least one type of the initial noise-indicative population types, based on the noise-indicative values determined for multiple other pixels which are proximate to the respective pixel.

17. The method according to claim 9, further comprising detecting defects in an inspected object that is imaged in the inspection image; wherein the detecting of the defects in each compared pixel of the inspection image is based on a comparison of a color level of the compared pixel to the color level of a corresponding reference pixel and on the provided classification of that pixel into a noise-indicative population type.

18. A program storage device readable by machine, tangibly embodying a program of instructions executable by the machine to perform method for classification of pixels in an inspection image into noise-indicative populations comprising the steps of:
analyzing at least a part of the inspection image to determine a noise-indicative value for each pixel out of a plurality of pixels of the part of the inspection image;
assigning an initial noise-indicative population type to each pixel of the plurality of pixels based on the noise-indicative value of that pixel, thus yielding a plurality of classified pixels;
processing at least some of the plurality of classified pixels, thereby assigning to at least one of the plurality of classified pixels a posterior noise-indicative population type which is different from the initial noise-indicative population type assigned to that reclassified pixel, based on the noise-indicative values determined for multiple other pixels which are proximate to that reclassified pixel; and
providing a classification of the plurality of pixels of the inspection image into noise-indicative population types, wherein the classification of at least one reclassified pixel is based on the posterior noise-indicative population type assigned to that reclassified pixel.

19. The program storage device according to claim 18, wherein the instructions comprised in the program of instructions for the step of processing comprise instructions for processing the at least some of the plurality of classified pixels, thereby assigning to the at least one of the plurality of classified pixels the posterior noise-indicative population type based on the noise-indicative values determined for the multiple other pixels whose proximity to that reclassified pixel is nearer than or equal to two pixels.

20. The program storage device according to claim 18, wherein the instructions comprised in the program of instructions for the step of analyzing comprise instructions for analyzing the part of the inspection image to determine for each of the plurality of pixels multiple noise-indicative values of multiple noise indicative parameters; wherein the assigning of the initial noise-indicative population type to each pixel of the plurality of pixels is based on the multiple noise-indicative values of that pixel; and wherein the processing includes assigning the posterior noise-indicative population type to the at least one reclassified pixel based on the multiple noise-indicative values determined for each of the multiple proximate pixels.
